(19) United States
(12) Patent Application Publication
(10) Pub. No.: US 2026/0236403 A1
(43) Pub. Date: Aug. 13, 2026

(54) INFORMATION PROCESSING DEVICE, INFORMATION PROCESSING DEVICE CONTROL METHOD, AND NON-TRANSITORY COMPUTER-READABLE MEDIUM IN WHICH PROGRAM IS STORED

(71) Applicant: NEC Corporation, Tokyo (JP)

(72) Inventors: Jun FURUKAWA, Tokyo (JP); Takuya HAYASHI, Tokyo (JP); Satsuya OHATA, Tokyo (JP); Tatsuya KUBO, Tokyo (JP)

(73) Assignee: NEC Corporation, Tokyo (JP)

(21) Appl. No.: 19/153,976

(22) PCT Filed: Feb. 14, 2023
(86) PCT No.: PCT/JP2023/005057

§ 371 Date: Aug. 6, 2025

(51) Int. Cl. G06F 12/14; G06F 21/60; H04L 9/32

(52) U.S. Cl. CPC G06F 12/14; G06F 21/60; H04L 9/32

(57) ABSTRACT

An information processing device comprises: an encryption engine with authentication that performs, with respect to data transferred between a data cache and a memory, an encryption process and an authentication process using an authentication tree composed of a plurality of nodes that are linked in a tree shape and that are assigned with respective sets of counters and identifiers; an authentication tree cache that has temporarily stored therein, as information relating to the authentication tree, a portion of tags generated by using the counters and the identifiers included in the authentication tree, and the counters and the identifiers included in the authentication tree; and a management unit that manages the storage status of the information relating to the authentication tree in the authentication tree cache.

### TECHNICAL FIELD

The present disclosure relates to an information processing device, an information processing device control method, and a non-transitory computer-readable medium in which a program is stored.

### BACKGROUND ART

In an information processing device mounted on a computer and the like, storage areas such as a register, a cache, a memory, and a storage are hierarchized. Here, in the data transfer between the cache and the memory, data authentication and data encryption and decryption are performed. As a result, it is possible to prevent leakage of data stored in the information processing device due to a physical attack on the information processing device from the outside. Hereinafter, the data authentication and the data encryption and decryption performed in the data transfer between the cache and the memory are also referred to as an authenticated encryption process.

In recent years, development of data authentication using an authentication tree composed of a plurality of nodes linked in a tree shape, to each of which a combination of a counter and an identifier is assigned, is underway. In the data authentication using the authentication tree, not only authentication for data but also authentication for an authenticator is performed, and thus the risk of data leakage is further reduced. A technique related to data authentication using an authentication tree is disclosed in, for example, PTL 1.

### CITATION LIST

### Patent Literature

PTL 1: JP 2022-540857 A

### Non Patent Literature

NPL 1: William Eric Hall and Charanjit S. Jutla. Parallelizable authentication trees. In Bart Preneel and Stafford E. Tavares, editors, Selected Areas in Cryptography, 12th International Workshop, SAC 2005, Kingston, ON, Canada, Aug. 11-12, 2005, Revised Selected Papers, volume 3897 of Lecture Notes in Computer Science, pages 95-109. Springer, 2005.
NPL 2: Shay Gueron. Memory encryption for general-purpose processors. IEEE Secur. Priv., 14(6):54-62, 2016.
NPL 3: Meysam Taassori, Ali Shafiee, and Rajeev Balasubramonian. VAULT: reducing paging overheads in SGX with efficient integrity verification structures. In Xipeng Shen, James Tuck, Ricardo Bianchini, and Vivek Sarkar, editors, Proceedings of the Twenty-Third International Conference on Architectural Support for Programming Languages and Operating Systems, ASPLOS 2018, Williamsburg, VA, USA, Mar. 24-28, 2018, pages 665-678. ACM, 2018.

### SUMMARY OF INVENTION

### Technical Problem

However, in a case where the authenticated encryption process is performed in the data transfer between the cache and the memory using the authentication tree disclosed in PTL 1, there is a problem in that the processing performance of the memory access deteriorates.

The present disclosure has been made to solve such a problem, and an object of the present disclosure is to provide an information processing device, an information processing device control method, and a non-transitory computer-readable medium in which a program is stored, which are capable of suppressing performance deterioration of memory access due to an authenticated encryption process in data transfer between a cache and a memory.

### Solution to Problem

An information processing device according to an aspect of the present disclosure includes a memory; a data cache; an authenticated encryption engine that performs, on data to be transferred between the data cache and the memory, an encryption process, and an authentication process using an authentication tree including a plurality of nodes linked in a tree shape, to each of which a combination of a counter and an identifier is assigned; an authentication tree cache that temporarily stores, as information regarding the authentication tree, a part of the counter and the identifier included in the authentication tree and a tag generated using the counter and the identifier included in the authentication tree; an authentication engine that performs an authentication process on the information regarding the authentication tree to be transferred between the authentication tree cache and the memory; and management means for managing a storage status of the information regarding the authentication tree in the authentication tree cache based on at least one of a storage status of data in the data cache and a storage status of the information regarding the authentication tree in the authentication tree cache.

A control method of an information processing device according to another aspect of the present disclosure is a control method of an information processing device including a memory, a data cache, an authenticated encryption engine that performs, on data to be transferred between the data cache and the memory, an encryption process, and an authentication process using an authentication tree including a plurality of nodes linked in a tree shape, to each of which a combination of a counter and an identifier is assigned, an authentication tree cache that temporarily stores, as information regarding the authentication tree, a part of the counter and the identifier included in the authentication tree and a tag generated using the counter and the identifier included in the authentication tree, and an authentication engine that performs an authentication process on the information regarding the authentication tree to be transferred between the authentication tree cache and the memory, and the control method includes managing a storage status of the information regarding the authentication tree in the authentication tree cache based on at least one of a storage status of data in the data cache and a storage status of the information regarding the authentication tree in the authentication tree cache.

A non-transitory computer-readable medium according to another aspect of the present disclosure is a non-transitory computer-readable medium in which a control program is stored, the control program causes a computer to execute a control process in an information processing device including a memory, a data cache, an authenticated encryption engine that performs, on data to be transferred between the data cache and the memory, an encryption process, and an authentication process using an authentication tree including a plurality of nodes linked in a tree shape, to each of which a combination of a counter and an identifier is assigned, an authentication tree cache that temporarily stores, as information regarding the authentication tree, a part of the counter and the identifier included in the authentication tree and a tag generated using the counter and the identifier included in the authentication tree, and an authentication engine that performs an authentication process on the information regarding the authentication tree to be transferred between the authentication tree cache and the memory, and the control process includes a process of managing a storage status of the information regarding the authentication tree in the authentication tree cache based on at least one of a storage status of data in the data cache and a storage status of the information regarding the authentication tree in the authentication tree cache.

### Advantageous Effects of Invention

The present disclosure can provide an information processing device, an information processing device control method, and a non-transitory computer-readable medium in which a program is stored, which are capable of suppressing performance deterioration of memory access due to an authenticated encryption process in data transfer between a cache and a memory.

### BRIEF DESCRIPTION OF DRAWINGS

FIG. 1 is a block diagram illustrating a configuration example of an information processing device according to a first example embodiment.

FIG. 2 is a diagram illustrating a configuration example of an information processing device according to a second example embodiment.

FIG. 3 is a conceptual diagram of an authentication tree.

FIG. 4 is a diagram illustrating a relationship between each node constituting an authentication tree and a cache line associated with the node.

FIG. 5 is a diagram for describing a non-cached ancestor sequence and a cached ancestor in an authentication tree.

FIG. 6 is a diagram for describing addition and deletion of nodes of an authentication tree.

FIG. 7 is a diagram for describing an optimization process using caches.

### EXAMPLE EMBODIMENT

Hereinafter, example embodiments will be described with reference to the drawings. In the example embodiments, the same or equivalent elements are denoted by the same reference numerals, and repeated description will be omitted.

### First Example Embodiment

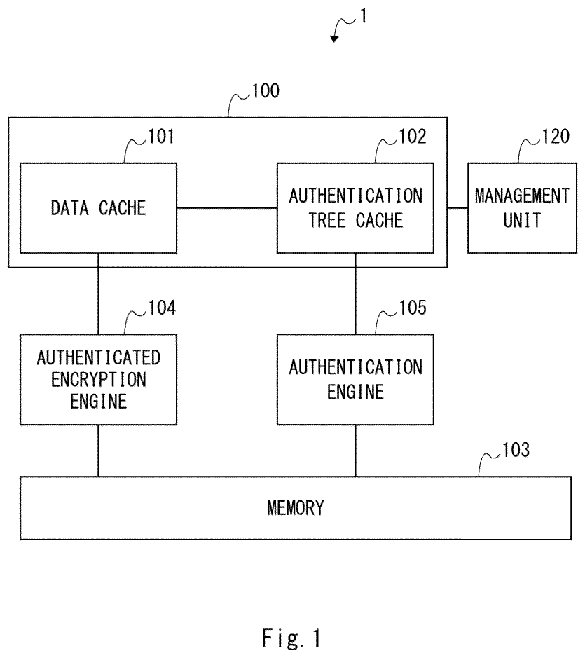

FIG. 1 is a block diagram illustrating a configuration example of an information processing device 1 according to a first example embodiment.

As illustrated in FIG. 1, the information processing device 1 includes a data cache 101, an authentication tree cache 102, a memory 103, an authenticated encryption engine 104, an authentication engine 105, and a management unit 120. The data cache 101 and the authentication tree cache 102 constitute a cache 100.

The authenticated encryption engine 104 performs, on the data to be transferred between the data cache 101 and the memory 103, an encryption process and an authentication process using an authentication tree composed of a plurality of nodes linked in a tree shape, to each of which a combination of a counter and an identifier is assigned.

The authentication tree cache 102 temporarily stores, as information regarding the authentication tree, a part of the counter and the identifier included in the authentication tree and a tag generated using the counter and the identifier included in the authentication tree. The authentication engine 105 performs an authentication process on the information regarding the authentication tree to be transferred between the authentication tree cache 102 and the memory 103.

The management unit 120 manages a storage status of the information regarding the authentication tree in the authentication tree cache 102 based on at least one of a storage status of the data in the data cache 101 and the storage status of the information regarding the authentication tree in the authentication tree cache 102. The management unit 120 may be provided as a part of functions of the authentication tree cache 102.

As described above, the information processing device 1 according to the first example embodiment can suppress the performance deterioration of the memory access due to the authenticated encryption process by actively using the authentication tree cache 102.

### Second Example Embodiment

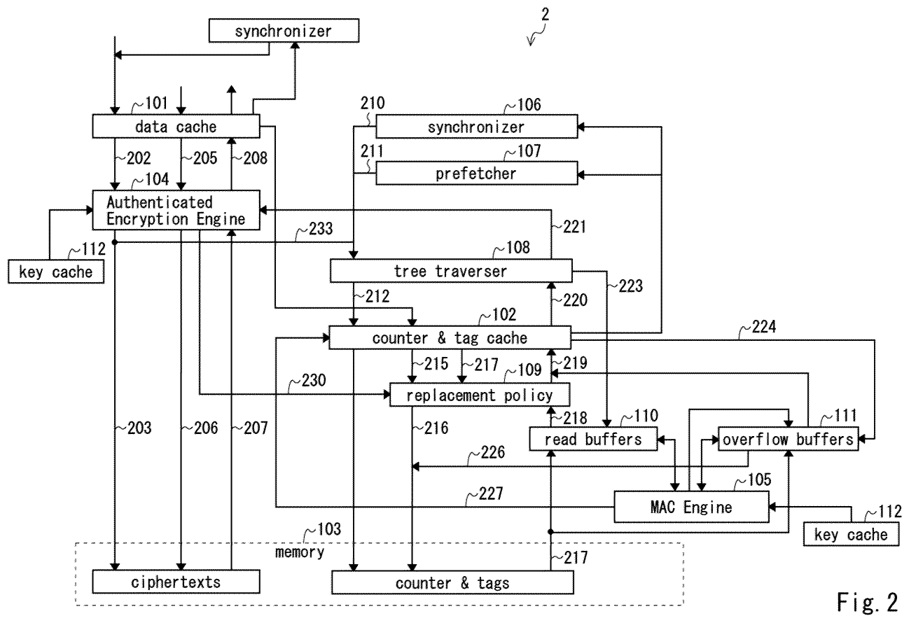

FIG. 2 is a diagram illustrating a configuration example of an information processing device 2 according to a second example embodiment. FIG. 2 is a diagram more specifically illustrating the information processing device 2 illustrated in FIG. 1. As illustrated in FIG. 2, the information processing device 2 includes the data cache 101, the authentication tree cache (counter and tag cache) 102, the memory 103, the authenticated encryption engine 104, the authentication engine 105, a synchronizer 106, a prefetcher 107, a tree traverser 108, a replacement policy 109, a buffer (read buffer) 110, a buffer (overflow buffer) 111, and a key cache 112. In the present example embodiment, a case where the management unit 120 is provided as a part of the functions of the authentication tree cache 102 will be described as an example.

### Basic Configuration of Information Processing Device 2

A basic configuration of the information processing device 2 according to the present example embodiment will be described.

In the present example embodiment, it is assumed that the data cache 101 is of a write-back type, and that data stored in the data cache 101 is identified by memory addresses. Any structure can be adopted for the data cache 101. For example, the data cache 101 may be configured with a single layer, or may be configured with a plurality of layers without being limited thereto. In the present example embodiment, a case where the data cache 101 includes three layers will be described as an example (described later).

In the present example embodiment, a case where data is written from a register (not illustrated) to the data cache 101 according to an instruction from a CPU and a case where data is written from the memory 103 to the data cache 101 according to an instruction from a memory management unit (MMU) will be described as examples of writing data to the data cache 101.

In the present example embodiment, a case where data is read from the data cache 101 to the register according to an instruction from the CPU, a case where an instruction is read from the data cache 101 to the CPU, and a case where data is read from the data cache 101 to the memory 103 according to an instruction from the MMU will be described as examples of reading data from the data cache 101.

In the present example embodiment, it is assumed that all pieces of data to be written to the data cache 101 is plaintext. It is assumed that data is transferred between a plurality of layers constituting the data cache 101 through a normal read operation and a normal write-back operation.

In the data transfer between the data cache 101 and the memory 103, the encryption and decryption of data are performed, and data authentication is also performed. In the present example embodiment, for example, a case where encryption and authentication of PAT type data are performed as disclosed in NPL 1 will be described as an example. A practical example of encryption and authentication of the PAT type data is disclosed in NPL 2, for example.

In the present example embodiment, data authentication is performed using the authentication tree composed of a plurality of nodes linked in a tree shape, to each of which a combination of a counter and an identifier is assigned. In the data authentication using the authentication tree, not only authentication for data but also authentication for an authenticator is performed, and thus the risk of data leakage is further reduced.

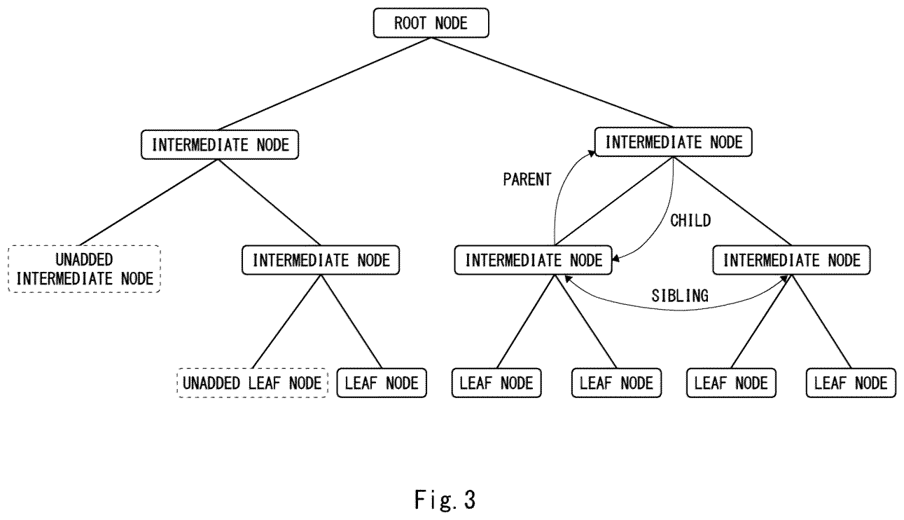

FIG. 3 is a conceptual diagram of the authentication tree. A counter and an identifier are assigned to each node constituting the authentication tree. An identifier of each leaf node (node at the lowest layer) matches a memory address of the associated cache line. An identifier of an intermediate node is derived based on the position in the tree. In addition, data associated with the memory address (identifier) is assigned to each leaf node. That is, in a case where data is written to the data cache 101, the data matches the cache line written to the data cache 101. The cache line written to the data cache 101 includes only data.

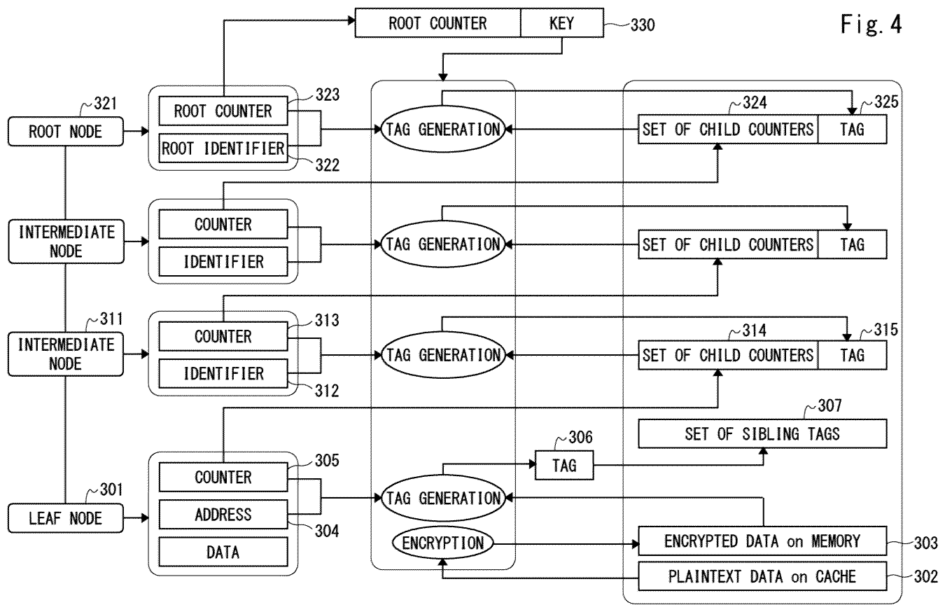

FIG. 4 is a diagram illustrating a relationship between each node constituting the authentication tree and the cache line associated with the node. As illustrated in FIG. 4, in each leaf node 301, encrypted data (hereinafter, simply referred to as ciphertext) 303 is generated from plaintext data 302 stored in an associated cache line, and a tag (authenticator, MAC) 306 is generated based on the ciphertext 303, a memory address 304, and a count value of a counter 305. The tag generated in each leaf node 301 is stored in another cache line 307 together with a tag generated in another node (sibling node) having a common intermediate node as a parent node.

In each intermediate node 311, a tag 315 is generated based on an assigned identifier 312, a count value of an assigned counter 313, and a set 314 of count values of counters of child nodes. Similarly, in a root node (node at the highest layer) 321, a tag 325 is generated based on an assigned identifier 322, a count value of an assigned counter 323, and a set 324 of count values of counters of child nodes.

Here, a case where a count value of a counter indicates “0” represents that an address assigned to each of the node to which the counter is assigned and its descendant nodes is not used (reading of data of the address is not performed). As a result, since the nodes not to be used are excluded from the authentication tree, an efficient operation is enabled even in a case where an address space is large but the amount of data to be used is small. A key 330 is also used for data encryption and tag generation.

In the present example embodiment, a case where each counter is of a split type will be described as an example. Details of the split-type counter are disclosed in, for example, NPL 3. The counter assigned to each node is a minor counter having a small area. A plurality of minor counters respectively assigned to a plurality of child nodes (sibling nodes) of a common node shares one major counter. This makes it possible to reduce the memory occupancy while enabling a large number of updates. For example, in a case where a count value of a certain minor counter exceeds a maximum value, a count value of a major counter thereof is counted up, and among the minor counter and minor counters assigned to the sibling nodes thereof, count values of all minor counters having count values other than “0” are reset to “1”. As described above, the address assigned to each of the node to which the counter indicating the count value “0” is assigned and its descendant nodes is not used.

It is assumed that each split-type counter is static, and an area assigned to each minor counter is always the same area. It is assumed that a major counter is on the same cache line as its minor counters. It is assumed that appropriate size and structure of the authentication tree are determined from a size of an address space to be a target for the authenticated encryption and the number of branches of each layer of the authentication tree.

Data (including instructions) is written to the data cache 101, and a counter and a tag used for data authentication are written to the authentication tree cache 102. The authentication tree cache 102 may be configured with a single layer as illustrated in FIG. 2, or may be configured with a plurality of layers without being limited thereto. It is assumed that each cache line is provided with a bit indicating either “valid” or “invalid” and a bit indicating either “dirty” or “clean”. The “valid” indicates that the cache line stored in the cache 100 is valid, and the “invalid” indicates that the cache line stored in the cache 100 is invalid. The “dirty” indicates that the cache line stored in the cache 100 is updated and is different from the associated cache line stored in the memory 103. The “clean” indicates that the cache line stored in the cache 100 is the same as the associated cache line stored in the memory 103.

In a case where data of a certain leaf node is updated, in principle, count values of all counters on a path from the leaf node to the root node are counted up. However, for some counters assigned to the nodes in the authentication tree cache 102, the count-up of count values may be performed with a delay, or the count-up of count values of a plurality of times may be collectively performed. The counter assigned to the root node is specially protected from being directly operated by an attacker. Then, a tag of the relevant node is updated based on the counter of the root node, the counter of each intermediate node, or the counter of each leaf node and the data. As a result, tags of the nodes follow the latest state. Here, by using a private key and the counter of the tamper-resistant root node, even when the ciphertext or the tag is tampered with or replaced with past data, such tampering and replacement can be detected. In a case where data of a certain leaf node is updated, not only authentication is performed on data of this leaf node, but also authentication is performed on tags (authenticators) of nodes present on a path from this leaf node to the root node, and thus the risk of data leakage is further reduced.

### Basic Operation of Information Processing Device 2

Next, a basic operation of the information processing device 2 will be described.

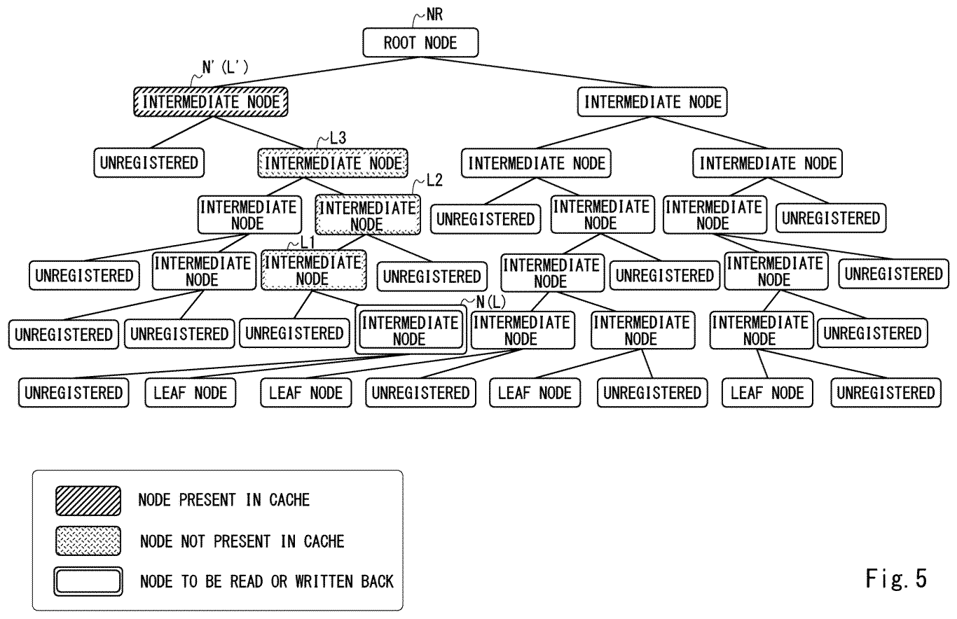

First, a protocol of data encryption and authentication adopted in the present example embodiment will be described with reference to FIG. 5. FIG. 5 is a diagram for describing a non-cached ancestor sequence and a cached ancestor in the authentication tree.

In the example of the authentication tree illustrated in FIG. 5, the path of the authentication tree is traced from a node N, to which a counter C of any cache line L belongs, toward a root node NR. Among the nodes present on this path, a counter of a node that is first encountered and is on the data cache 101 is referred to as a counter C′. The m+1 counters of the nodes present on the path from the node N, to which the counter C belongs, to the node N′, to which counter C′ belongs, are referred to as counters C, C1, . . . , and Cm (where Cm=C′) in the tracing order. In the case of m=0, the counter C and the counter C′ match. The m+1 cache lines in which the m+1 counters are respectively stored are referred to as cache lines L, L1, . . . , and Lm (where Lm=L′) in the tracing order. In the case of m=0, the cache line L and the cache line L′ match. In the example of FIG. 5, a case of m=3 is illustrated.

Here, among the cache lines L1 to Lm, the cache lines L1 to Lm−1 that are not present in the authentication tree cache 102 are referred to as a “non-cached ancestor sequence”, the cache line Lm (=L′) is referred to as a “cached ancestor”, the counters C1 to Cm−1 are referred to as a “counter ancestor sequence” of the cache line L, and the counter Cm (=C′) is referred to as a “cached ancestor counter” of the cache line L. In a case where a tag of each element in the cached ancestor sequence is not included in the current sequence elements, the sequence including only these tags is referred to as a “non-cached ancestor sequence tag”. In this case, it is assumed that the cache line to which each element of the non-cached ancestor sequence tag belongs includes only the tag.

### Initialization of Authentication Tree

Next, initialization of the authentication tree will be described. Specifically, first, a count value of a counter (root counter) assigned to the root node is counted up by one. Thereafter, information regarding the data and the sequence of the address is acquired. The data does not need to exist for all addresses. Thereafter, an authentication tree covering only the addresses where data exists among all addresses of the memory 103 is generated. That is, the count values of all the counters assigned to all the leaf nodes to which the address where the data exists is assigned as the identifier and all the intermediate nodes and the root node having the leaf nodes as the child nodes or the grandchild nodes are reset to “1”. The count values of the other counters are set to “0”.

A cache line in which a set of count values of the counters of the child nodes of the intermediate nodes and the root node is stored is formed, and a tag thereof is also generated. The tag assigned to each of the intermediate nodes and the root node is generated based on the identifier and the count value of the counter assigned to the node, and a set of the count values of the counters of the child nodes stored in the cache line. The tag may be stored together with the cache line in which a set of count values of the counters of the child nodes is stored, or may be stored in a cache line provided separately from the cache line in which a set of count values of the counters of the child nodes is stored. For each leaf node, a cache line in which data (authenticated ciphertext) assigned to the node is stored is formed, and a tag thereof is also generated. The tag generated in each leaf node is stored in another cache line together with a tag generated in another node (sibling node) having a common intermediate node as a parent node.

Thereafter, all these cache lines are stored in the memory 103. In this way, the initialization of the authentication tree is performed.

### Reading of Cache Line L by Cache 100

Next, the read operation of the cache line L by the cache 100 will be described. In the following description, it is assumed that the cache line L has been added (registered) as a node of the authentication tree. It is assumed that a cache line Lc present at a read destination of cache line L in the storage area of the cache 100 is in either an invalid state or a valid and clean state. In a case where the cache line Lc is in a valid and dirty state, it is necessary to set the cache line Lc to an invalid state or a valid and clean state through a write-back process or a synchronization process of the cache line Lc, which will be described later, to the memory 103.

In a case where the cache line L is data, the data cache 101 designates a read destination (address) of the cache line L via a signal line 202, and in a case where the cache line L is a counter and a tag, the prefetcher 107 designates a read destination (address) of the cache line L in the authentication tree cache 102 to the tree traverser 108 via a signal line 211.

In the authentication tree, in a case where there is a non-cached ancestor sequence of the cache line L (that is, in a case where the authenticated encryption engine 104 is unable to acquire a counter and a tag at an address designated via a signal line 233, the tree traverser 108, and a signal line 212 from the authentication tree cache 102 via a signal line 220, the tree traverser 108, and a signal line 221), the non-cached ancestor sequence is read from the memory 103 and written to the buffer 110 via a signal line 217.

At this time, the tree traverser 108 sequentially generates the address sequence of the ancestors of cache line L from the node, to which the address received from the authenticated encryption engine 104 is assigned, toward the root node, and sequentially queries the authentication tree cache 102 to check whether the cache lines of the generated addresses are stored in the authentication tree cache 102. The tree traverser 108 terminates the query when the cached ancestor L′ of the cache line L is returned from the authentication tree cache 102 via the signal line 220. Thereby, the tree traverser 108 may acquire the cached ancestor L′ and the non-cached ancestor sequence L1 to Lm−1.

In the authentication tree, in a case where there is a non-cached ancestor sequence tag of the cache line L, the non-cached ancestor sequence tag is read from the authentication tree cache 102 or the memory 103 and written to the buffer 110. In a case where the non-cached ancestor sequence tag is read from the memory 103, the cache line to which the non-cached ancestor sequence tag belongs is read from the memory 103 and written to the buffer 110 via the signal line 217.

In a case where the tag is not included in the cache line L, a tag T of the cache line L is read from the authentication tree cache 102 or the memory 103 and written to the buffer 110. In a case where the tag T of the cache line L is read from the memory 103, the cache line L to which the tag T belongs is read from the memory 103 and written to the buffer 110 via the signal line 217.

In a case where the cache line L is data, encrypted data (ciphertext) is read from the memory 103 and received by the authenticated encryption engine 104 via a signal line 207. On the other hand, in a case where the cache line L is a counter, the counter is read from the memory 103 and written to the buffer 110 via the signal line 217.

The tree traverser 108 also receives the cached ancestor counter C′ of the cache line L read from the authentication tree cache 102, via the signal line 220 and writes the cached ancestor counter C′ to the buffer 110 via a signal line 223.

Thereafter, the authentication engine 105 verifies the non-cached ancestor sequence L1 to Lm−1 written to the buffer 110 sequentially one by one from the cache line Lm−1 to the cache line L1. In a case where the cache line L is a counter, the authentication engine 105 further verifies the cache line L. These verifications are performed as appropriate using the cached ancestor counter C′ of the cache line L, the non-cached ancestor sequence L1 to Lm−1, the non-cached ancestor sequence tag, and the tag T in the case where the cache line L is a counter, all of which are written to the buffer 110, and the key stored in the key cache 112. In a case where the verification fails, the authentication engine 105 immediately returns a verification rejection to the data cache 101.

Thereafter, in a case where the cache line L is data, the tree traverser 108 transmits the cache line LI and the tag T of the cache line L to the authenticated encryption engine 104 via the signal line 221. The authenticated encryption engine 104 performs verification using the cache line L1, the tag T of the cache line L, the cache line L received from the memory 103, and the key stored in the key cache 112.

In a case where the cache line L is data, the authenticated encryption engine 104 decrypts the encrypted data that has passed the verification, into the plaintext and then writes the decrypted data into the data cache 101 via a signal line 208. On the other hand, in a case where the cache line L is a counter, the authentication engine 105 writes the counter that has passed the verification, to the authentication tree cache 102 via a signal line 227.

The non-cached ancestor sequence L1 to Lm−1 of the cache line L written to the buffer 110 is either written to a writable area (that is, a cache line in an invalid state or in a valid and clean state) of the authentication tree cache 102 via a signal line 218, the replacement policy 109, and a signal line 219, or discarded when no writable area is available. At the time when a query is issued from the tree traverser 108 to the authentication tree cache 102 via the signal line 212, the authentication tree cache 102 transmits information regarding whether the non-cached ancestor sequence is written to the authentication tree cache 102 or discarded, to the replacement policy 109 via the signal line 217. The cache line written to the authentication tree cache 102 is set to a valid and clean state.

Among the cache lines to which the tag T and the non-cached ancestor sequence tag of the cache line L belong, the cache line written only to the buffer 110 is written to the authentication tree cache 102 or discarded via the signal line 218, the replacement policy 109, and the signal line 219. In a case where the cache line written to the buffer 110 is written to the authentication tree cache 102, when the cache line evicted from the authentication tree cache 102 is in a dirty state, the evicted cache line is written back to the memory 103. The cache line newly written to the authentication tree cache 102 is set to a valid and clean state.

### Write-Back of Cache Line L from Cache 100 to Memory 103

Next, the write-back operation of the cache line L from the cache 100 to the memory 103 will be described. In the following description, it is assumed that the cache line L has been added (registered) as a node of the authentication tree. It is assumed that the cache line L is in a valid and dirty state.

In a case where the cache line L is data, the data cache 101 sends the data via a signal line 205, and designates an address of the write-back destination via the signal line 202. In a case where the cache line L is a counter, the synchronizer 106 designates an address of the write-back destination of the cache line L to the tree traverser 108 via a signal line 210.

In the authentication tree, in a case where there is a non-cached ancestor sequence of the cache line L (that is, in a case where the authenticated encryption engine 104 is unable to acquire a counter and a tag at an address designated via the signal line 233, the tree traverser 108, and the signal line 212 from the authentication tree cache 102 via the signal line 220, the tree traverser 108, and the signal line 221), the non-cached ancestor sequence is read from the memory 103 and written to the buffer 110 via the signal line 217.

At this time, the tree traverser 108 sequentially generates the address sequence of the ancestors of cache line L from the node, to which the address received from the authenticated encryption engine 104 is assigned, toward the root node, and sequentially queries the authentication tree cache 102 to check whether the cache lines of the generated addresses are stored in the authentication tree cache 102. The tree traverser 108 terminates the query when the cached ancestor L′ of the cache line L is returned from the authentication tree cache 102 via the signal line 220. Thereby, the tree traverser 108 may acquire the cached ancestor L′ and the non-cached ancestor sequence L1 to Lm−1.

In the authentication tree, in a case where there is a non-cached ancestor sequence tag of the cache line L, the non-cached ancestor sequence tag is read from the authentication tree cache 102 or the memory 103 and written to the buffer 110. In a case where the non-cached ancestor sequence tag is read from the memory 103, the cache line to which the non-cached ancestor sequence tag belongs is read from the memory 103 and written to the buffer 110 via the signal line 217.

In a case where the tag is not included in the cache line L, the tag T of the cache line L is read from the authentication tree cache 102 or the memory 103 and written to the buffer 110. In a case where the tag T of the cache line L is read from the memory 103, the cache line L to which the tag T belongs is read from the memory 103 and written to the buffer 110 via the signal line 217.

The tree traverser 108 also receives the cached ancestor counter C′ of the cache line L read from the authentication tree cache 102, via the signal line 220 and writes the cached ancestor counter C′ to the buffer 110 via the signal line 223.

Thereafter, the authentication engine 105 verifies the non-cached ancestor sequence L1 to Lm−1 written to the buffer 110 sequentially one by one from the cache line Lm−1 to the cache line L1. These verifications are performed as appropriate using the cached ancestor counter C′ of the cache line L, the non-cached ancestor sequence L1 to Lm−1, and the non-cached ancestor sequence tag, all of which are written to the buffer 110, and the key stored in the key cache 112. In a case where the verification fails, the authentication engine 105 immediately returns a verification rejection to the data cache 101.

Thereafter, the authentication engine 105 counts up, by one, the count value of each of the counter ancestor sequence C1 to Cm−1 of the cache line L and the cached ancestor counter C′ of the cache line L which are written to the buffer 110. The cached ancestor L′ of the cache line L written in the authentication tree cache 102 is set to a dirty state.

Here, in a case where any one of minor counters among the counters C1 to Cm−1 and C′ overflows, the processing in steps S1 to S6 below is performed. A set of the sibling counters of the counters C1 to Cm−1 and C′ having the count value other than “0” is set as Ca. A set of cache lines that are descendants of the counter set Ca is set as La. In the cache line set La, the cache line set that is not present in the authentication tree cache 102 is referred to as Lb. A set of tags of the cache line Lb is referred to as Tb.

In step S1, first, the cache line set Lb is read from the memory 103 and written to the buffer 111 via the signal line 217. In a case where the tag set Tb is present in the authentication tree cache 102, the tag set Tb is written from the authentication tree cache 102 to the buffer 111 via a signal line 224, and in a case where the tag set Tb is not present in the authentication tree cache 102, the tag set Tb is written from the memory 103 to the buffer 111 via the signal line 217. In a case where the tag set Tb is read from the memory 103, the cache line to which the tag set Tb belongs is read from the memory 103 and written to the buffer 111 via the signal line 217.

In step S2, the authentication engine 105 resets the count values of the minor counters of all the elements of the counter set Ca written in the buffer 111 to “1”.

In step S3, in the cache line set La, the cache line present in the authentication tree cache 102 (that is, in the cache line set La, the cache line other than the cache line set Lb) is set to a dirty state.

In step S4, the authentication engine 105 updates the tag set Tb using the cache line set Lb and the counter set Ca.

In step S5, the cache line to which the tag, which is present in the authentication tree cache 102, in the updated tag set Tb belongs is set to a dirty state.

In step S6, the cache line to which the tag, which is not present in the authentication tree cache 102, in the updated tag set Tb belongs is read from the buffer 111 and written back to the memory 103 via a signal line 226.

Thereafter, the tag of each of the non-cached ancestor sequence L1 to Lm−1 of the cache line L and the cached ancestor L′ of the cache line L1 written to the buffer 110 is updated.

Thereafter, in a case where the cache line L is data, the authenticated encryption engine 104 updates the tag T based on the cache line L and the counter C. In a case where the cache line L is data, the authentication engine 105 updates the tag T based on the cache line L and the counter C. In a case where the cache line L is data, the authenticated encryption engine 104 also generates the ciphertext (encrypted data) E of the cache line L.

In the case of the write-back operation, the cache line L in the cache is set to an invalid state. Specifically, in a case where the cache line L is data, the cache line L stored in the data cache 101 is set to an invalid state, and in a case where the cache line L is a counter, the cache line L stored in the authentication tree cache 102 is set to an invalid state. On the other hand, in the case of the synchronization operation, the cache line L in the cache is set to a clean state. Specifically, in a case where the cache line L is data, the cache line L stored in the data cache 101 is set to a clean state, and in a case where the cache line L is a counter, the cache line L stored in the authentication tree cache 102 is set to a clean state. In a case where the cache line L is data, the ciphertext E is written back from the authenticated encryption engine 104 to the memory 103 via a signal line 206, and in a case where the cache line L is a counter, the counter is written back from the authentication tree cache 102 to the memory 103 via a signal line 215, the replacement policy 109, and a signal line 216.

The non-cached ancestor sequence L1 to Lm−1 of the cache line L written to the buffer 110 may be written to a writable area (that is, a cache line in an invalid state or in a valid and clean state) of the authentication tree cache 102 via the signal line 218, the replacement policy 109, and the signal line 219. The cache line written to the authentication tree cache 102 is set to a valid and clean state. Among the non-cached ancestor sequence L1 to Lm−1 of the cache line L written to the buffer 110, the cache line that has not been written to the authentication tree cache 102 is written back to the memory 103 via the signal line 218, the replacement policy 109, and the signal line 216. However, in a case where the cache line L is data, the counter and the tag assigned to the parent node are written from the authentication tree cache 102 to the authenticated encryption engine 104 via the signal line 220, the tree traverser 108, and the signal line 221.

The authentication engine 105 updates, among the cache lines to which the tag T and the non-cached ancestor sequence tag of the cache line L respectively belongs, the cache line present in the authentication tree cache 102 using the cache line written in the buffer 110. In the authentication tree cache 102, the updated cache line is set to a dirty state. The cache line that is not present in the authentication tree cache 102 but is present in the buffer 110 is determined by the replacement policy 109 via the signal line 218, and then is either written back to the memory 103 via the signal line 216 or written to the authentication tree cache 102 via the signal line 219. However, in a case where the cache line L is data, the counter and the tag assigned to the parent node are transmitted from the authentication tree cache 102 to the authenticated encryption engine 104 via the signal line 220, the tree traverser 108, and the signal line 221. At this time, the tag is updated by the authenticated encryption engine 104. The tag is determined by the replacement policy 109 from the authenticated encryption engine 104 via a signal line 230, and then is written back to the memory 103 via the signal line 216 or written to the authentication tree cache 102 via the signal line 219. In a case where the cache line L is written to the authentication tree cache 102, when the cache line evicted from the authentication tree cache 102 is in a dirty state, the evicted cache line is written back to the memory 103. The cache line newly written to the authentication tree cache 102 is set to a valid and clean state.

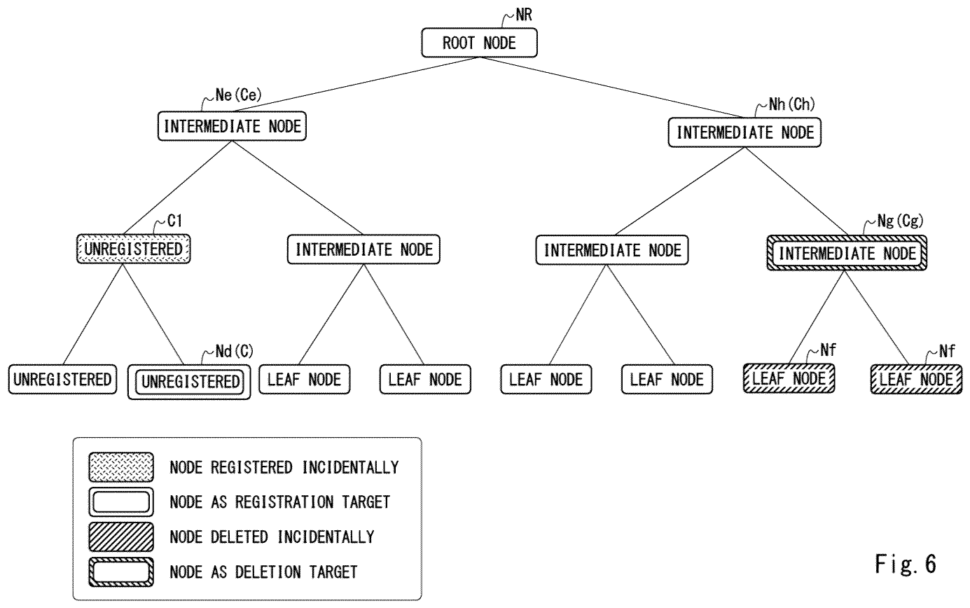

Next, addition and deletion of nodes of the authentication tree will be described with reference to FIG. 6.

FIG. 6 is a diagram for describing addition and deletion of nodes of the authentication tree.

### Addition of Node

First, processing contents in a case where the node of the cache line L is added as a new node of the authentication tree will be described.

In the following description, it is assumed that the cache line L is already stored in the authentication tree cache 102. The cache line to be added as a new node of the authentication tree is not a cache line to be read into the authentication tree cache 102 from the memory 103, but is a cache line to be written into the authentication tree cache 102 from a register afterward. Therefore, the description of the read operation of the cache line from the memory 103 to the authentication tree cache 102 will be omitted below.

In the example of FIG. 6, the path of the authentication tree is traced from a node Nd, to which the counter C of any cache line L belongs, toward the root node NR. Among the nodes present on the path, the counter of a node Ne that is first encountered and has been added to the authentication tree is referred to as a counter Ce. The m+1 counters of the nodes present on the path from the node, to which the counter C belongs, to the node, to which counter Ce belongs, are set as counters C, and C1 to Cm (where Cm=Ce) in the tracing order.

In a case where a cache line Le including the counter Ce is not present in the authentication tree cache 102, the cache line Le is read into the authentication tree cache 102 using a reading protocol. The count value of the counter Ce indicates “0”.

Thereafter, the count value of the counter Ce of the cache line Le written to the authentication tree cache 102 is set to “1”. The cache line Le written to the authentication tree cache 102 is set to a dirty state.

Thereafter, in a case where m is other than 0, the count value of each of the counters C1 to Cm−1 is set to “1”. The cache lines L1 to Lm−1 respectively including the counters C1 to Cm−1 are written to the buffer 110. Each of the count values of the sibling counters of the counters C1 to Cm−1 is set to “0”.

Thereafter, the tags T1 to Tm−1 of the cache lines L1 to Lm−1 are generated. If necessary, the cache lines including these tags T1 to Tm−1 are also separately generated and written to the buffer 110.

The cache lines L1 to Lm−1 and cache lines including the tags T1 to Tm−1, which are written to the buffer 110, are written to the authentication tree cache 102 or written back to the memory 103. In a case where the cache line is written to the authentication tree cache 102, when the cache line evicted from the authentication tree cache 102 is in a dirty state, the evicted cache line is written back to the memory 103. The cache line newly written to the authentication tree cache 102 is set to a valid and clean state. In the generation of the cache line, the value of the tag that is not present such as the count value of the associated counter of “0” may be set to any value.

Thereafter, the cache lines L1 to Lm−1 are either written to a writable area (a cache line in an invalid state or in a valid and clean state) of the authentication tree cache 102, or written back to the memory 103 when no writable area is available. The cache line written to the authentication tree cache 102 is set to a valid and clean state.

Thereafter, the tag T of the cache line L is generated. If necessary, the cache line including the tag T is also generated and written to the buffer 110. The cache line including the tag T is either written to the authentication tree cache 102 or written back to the memory 103. In a case where the cache line including the tag T is written to the authentication tree cache 102, when the cache line evicted from the authentication tree cache 102 is in a dirty state, the evicted cache line is written back to the memory 103. The cache line newly written to the authentication tree cache 102 is set to a valid and clean state. In the generation of the cache line, the value of the tag that is not present such as the count value of the associated counter of “0” may be set to any value.

### Deletion of Node

Next, processing contents in a case where the node Ng of the cache line Lg and the descendant node Nf thereof are deleted from the nodes of the authentication tree will be described. In the following description, it is assumed that the node Ng has been added as the node of the authentication tree.

In the example of FIG. 6, in a case where a cache line Lg storing a counter Cg of the node Ng and a cache line Lh storing a counter Ch of the parent node Nh of the cache line Lg are not present in the authentication tree cache 102, the cache line Lg and the cache line Lh are read into the authentication tree cache 102 using the reading protocol.

Thereafter, the count value of the counter Ch written to the authentication tree cache 102 is counted up by one. The cache line Lh including the counter Ch written to the authentication tree cache 102 is set to a dirty state.

Thereafter, the count value of the counter Cg is set to “0”, and thereby the cache line Lg is updated. The updated cache line Lg is set to a clean state.

Thereafter, all the cache lines associated with the descendant node Nf of the node Ng stored in the authentication tree cache 102 are set to an invalid state.

### Optimization Process by Authentication Tree Cache 102

As described above, in the information processing device 2, the authenticated encryption process is executed in association with normal memory access. However, as a result of this process, the authentication tree cache 102 is not necessarily in an optimal state, and for example, at the time of accessing the memory 103 from the data cache 101, the requested authenticator (tag) may not be available with a small delay and a small memory bus usage. In fact, the performance deterioration of the memory bus is not negligible. The information processing device 2 according to the present example embodiment suppresses the performance deterioration of the memory access due to the authenticated encryption process by actively using the authentication tree cache 102.

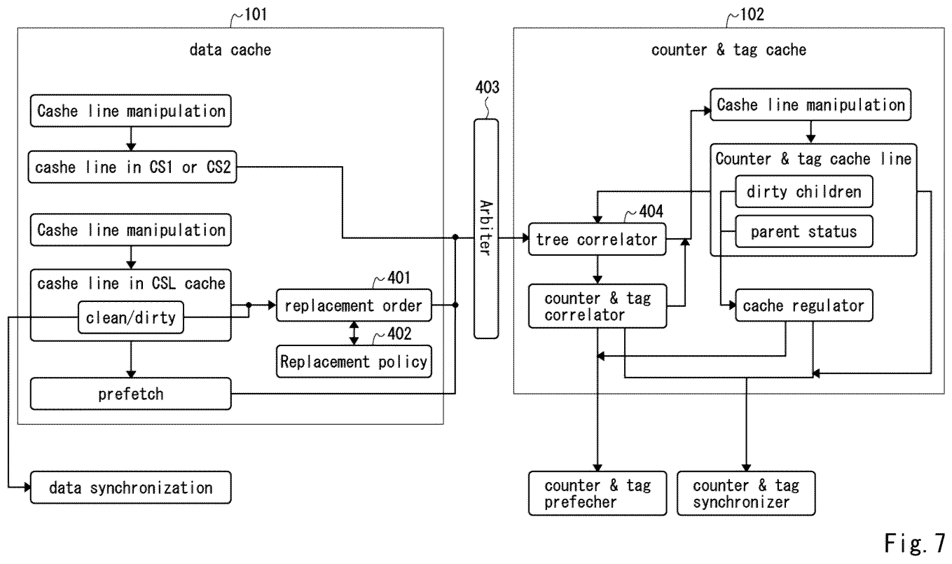

FIG. 7 is a diagram for describing an optimization process using the cache 100. Here, in a case where the data cache 101 is operated with memory access, information regarding the cache line of the operated address in the data cache 101 and the slot to which the cache line belongs (for example, n cache lines in the case of n-way) is transmitted to the authentication tree cache 102. In the authentication tree cache 102, management of the counter and the tag used for the authentication is optimized based on information received from the data cache 101 and operation information in the authentication tree cache 102. Hereinafter, a specific description will be given.

### Optimization Process 1

Since the data stored in the caches CS1 and CS2 of the upper layer among a plurality of layers constituting the data cache 101 is accessed frequently, there is a low possibility that the data is migrated to a cache CSL of the lowest layer or is evicted from the cache CSL of the lowest layer. Therefore, the data cache 101 transmits hit and miss information in a case where an operation such as writing or reading to the cache of the upper layer is performed, to the authentication tree cache 102 together with the information of the accessed address, as information regarding the cache line that is difficult to be evicted from the data cache 101. In the case of NINE, the cache line may be evicted from the cache of the lowest layer, but is less likely to be evicted in a case of being stored in the cache of the upper layer.

At this time, the authentication tree cache 102 (more specifically, the management unit 120) performs management in such a way that a counter and a tags used for the authentication of the cache line (frequently accessed cache lines) that is less likely to be evicted from the data cache 101 are not evicted from (are retained in) the authentication tree cache 102.

### Optimization Process 2

In the data cache 101, for example, an eviction candidate 401 of a cache line is set for each index. For example, the data cache 101 transmits the eviction candidate 401 to the authentication tree cache 102 as information regarding a cache line which is likely to be evicted from the data cache 101, at the timing of accessing the data cache 101.

For example, in a case where a replacement policy 402 is LRU or the like, the next cache line to be evicted is clearly determined. On the other hand, even in a case where an eviction target of the cache line is randomly determined, it is sufficient that the replacement policy 402 is set to prepare the eviction candidate 401 before the cache line as the randomly selected eviction target is evicted from the data cache 101.

At this time, the authentication tree cache 102 performs management in such a way that a counter and a tag used for the authentication of the cache line that is likely to be evicted from the data cache 101 are read in advance or are not evicted from the authentication tree cache 102.

### Optimization Process 3

Normally, the eviction of the synchronized cache line (that is, the cache line in which meta-information indicates “clean”) among the cache lines stored in the data cache 101 can be achieved by a simple process as compared with the case of the eviction of the unsynchronized cache line (that is, the cache line in which the meta-information indicates “dirty”).

Therefore, the data cache 101 sets the replacement policy 402 in such a way that the priority of the eviction target of the synchronized cache line among the cache lines stored in the data cache 101 is higher than the priority of the eviction target of the other cache lines. For example, the data cache 101 reads the meta-information of the accessed cache line, and set the accessed cache line as the eviction candidate 401 in a case where the read meta-information indicates “clean”. Then, the data cache 101 transmits the eviction candidate 401 to the authentication tree cache 102 as information regarding the cache line which is likely to be evicted from the data cache 101.

At this time, the authentication tree cache 102 performs management in such a way that a counter and a tag used for the authentication of the cache line that is likely to be evicted from the data cache 101 are read in advance or are not evicted from the authentication tree cache 102.

### Optimization Process 4

In a case where the data cache 101 is, for example, the n-way, at least one cache line among a plurality of cache lines constituting each index is synchronized. As a result, the cache line can be written to each index. For example, the data cache 101 reads the meta-information of each of the plurality of cache lines included in the accessed index, and synchronizes any cache line included in the accessed index in a case where the number of pieces of meta-information indicating “clean” is equal to or less than a predetermined number.

### Optimization Process 5

The data cache 101 transmits the information in a prefetch queue to the authentication tree cache 102 as information regarding the cache line which is likely to be written to the data cache 101. At this time, the authentication tree cache 102 performs management in such a way that a counter and a tag used for the authentication of the cache line that is likely to be written to the data cache 101 are read in advance or are not evicted from the authentication tree cache 102.

The data cache 101 may transmit a plurality of pieces of information (a plurality of pieces of address information) necessary for the optimization process to the authentication tree cache 102. In such a case, an arbitration device 403 provided between the data cache 101 and the authentication tree cache 102 assigns priorities to a plurality of pieces of information.

### Optimization Process 6

The ancestor counters of successive data belong to the adjacent nodes on the same layer in the authentication tree. In a case where successive data is read, when the counter of any node of the authentication tree is operated, the authentication tree cache 102 prefetches the counter of the node that is on the same layer as and adjacent to the operated node. Here, the authentication tree cache 102 does not immediately read the prefetched counter, but instead synchronizes the cache line of the read destination for the prefetched counter to prepare for the reading of the prefetched counter.

### Optimization Process 7

For example, in a case where a counter of any node in the authentication tree and the associated tag are stored in different cache lines, when the counter of the any node is stored in the authentication tree cache, the authentication tree cache 102 performs management in such a way that the associated tag is acquired and stored. However, the priority of the counter is higher than the priority of the tag. In a case where a counter of any node is stored in the authentication tree cache 102, the associated tag is checked for presence in the authentication tree cache.

### Optimization Process 8

Since it is difficult to synchronize the cache lines of data associated with counters that are not stored in the authentication tree cache 102, such cache lines of data are prioritized for synchronization. Specifically, in the authentication tree cache 102, a tree correlator 404 checks whether the counter associated with the data stored in the data cache 101 is stored in the authentication tree cache 102, and returns the check result to the data cache 101. Based on the check result, the data cache 101 prioritizes the synchronization of the cache lines of the data associated with the counters that are not stored in the authentication tree cache 102, over the cache lines of the data associated with the counters that are not stored in the authentication tree cache 102. In this case, since it is preferable that the counters stored in the authentication tree cache 102 are kept synchronized, the counters are always synchronized as long as memory access capacity allows.

### Optimization Process 9

In a case where the authentication tree cache 102 is the n-way, at least one cache line (counter) among the plurality of cache lines constituting each index is synchronized each time the authentication tree cache 102 is accessed. As a result, the cache line (counter) can be written to each index.

### Optimization Process 10

In a case where any counter is evicted from the authentication tree cache 102, there is a high possibility that a counter of a node that is on the same layer as and adjacent to the node of the any counter is also evicted. Therefore, in a case where any counter is evicted from the authentication tree cache 102, a counter of a node that is on the same layer as and adjacent to the node of the any counter is synchronized.

### Optimization Process 11

In a case where any cache line (counter) is evicted from the authentication tree cache 102, the cost of the synchronization of the cache lines of the child nodes of the node of the cache line is increased significantly. Therefore, in a case where any cache line (counter) is evicted from the authentication tree cache 102, the meta-information of the cache lines of the child nodes of the node of the cache line is checked in advance, and the cache lines of the child nodes in which the meta state indicates “dirty” are synchronized.

### Optimization Process 12

In a case where the cache line which is stored in the authentication tree cache 102 and in which meta-information indicates “dirty” is written back to the memory 103, the cache line of the parent node is required. Therefore, in a case where the counter of the parent node of the cache line in which the meta-information indicates “dirty” is not stored in the authentication tree cache 102, the authentication tree cache 102 performs management to read the counter of the parent node of the cache line in which the meta-information indicates “dirty”.

### Optimization Process 13

In the authentication tree cache 102, the tree correlator 404 enables eviction from the authentication tree cache 102 by identifying and synchronizing the counters associated with the cache lines evicted from the data cache 101.

The information processing device 2 according to the present example embodiment employs all or some of the plurality of optimization processes described above.

In a case where the cache capacity for counters and tags is about 64 MiB and the authentication tree cache 102 is 8-way, there will be 128,000 different indices. This is represented using 17 bits and, depending on the packing, corresponds to 6/11, 4/6, or ⅝ layers of addresses. In a case where all the counters from a counter belonging to a certain leaf node up to a counter belonging to its ancestor node share the same index, it may be difficult to write back some of these counters to the memory 103. For example, this may occur when some of the counters on the same path monopolize a certain index, and there is no space left in the index when attempting to read another counter in order to write one of the counters back to the memory 103.

A plurality of addresses including counters and tags on the same path is preferably assigned in such a way that duplication is reduced and bias is reduced to use the authentication tree cache 102 evenly. Here, since the second layer is 1/32 to ⅛ the size of the first layer and the third layer is 1/32 to 1/16 the size of the second layer, it is sufficient to assign addresses in the remaining layers simply in such a way to avoid overlapping and not to be confined to disproportionately small areas, as long as the addresses in the first layer or in the combined first and second layers are evenly distributed. For example, by reserving 3 bits somewhere and assigning up to 8 layers to these bits, overlapping can be avoided. Each layer is limited to, at most, ⅛ of the range, and it can be said that the limitation is sufficiently loose since the amount is also equal to or less than ⅛ of the first layer.

In a case where there is a cache line including only a tag, it is also conceivable that the cache line is not stored in the authentication tree cache, but is stored in the regular data cache. This is because the tag itself does not need to be authenticated at the time of reading and there is no problem in terms of safety even in a case where the tag is handled in the same manner as normal data. However, the cache schedule is different from that of the data, for example, it is convenient to bring the tag into the cache in conjunction with the counter. To implement the cache schedule without modifying the data cache, it is convenient to store the tag in the authentication tree cache.

As described above, the information processing device 2 according to the present example embodiment can suppress the performance deterioration of the memory access due to the authenticated encryption process by actively using the authentication tree cache 102.

The present disclosure can be achieved by causing a central processing unit (CPU) to execute a computer program for a part or all of the processes of the information processing device according to the above example embodiments.

The above-described program includes a command group (or software codes) for causing a computer to perform one or more functions that have been described in the example embodiments in a case where the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD), or other memory technology, a CD-ROM, a digital versatile disc (DVD), a Blu-ray (registered trademark) disk, or other optical disk storages, a magnetic cassette, a magnetic tape, a magnetic disk storage, or other magnetic storage devices. The program may be transmitted through a transitory computer-readable medium or a communication medium. As an example and not by way of limitation, the transitory computer-readable medium or the communication medium includes propagated signals in electrical, optical, acoustic, or any other form.

Although the example embodiments of the present disclosure have been described above in detail with reference to the drawings, specific configurations are not limited to the above, and various design changes and the like can be made without departing from the gist of the present disclosure.

Some or all of the above-described example embodiments may be described as the following Supplementary Notes, but are not limited to the following Supplementary Notes.
(Supplementary Note 1)

An information processing device including:
a memory;
a data cache;
an authenticated encryption engine that performs, on data to be transferred between the data cache and the memory, an encryption process, and an authentication process using an authentication tree including a plurality of nodes linked in a tree shape, to each of which a combination of a counter and an identifier is assigned;
an authentication tree cache that temporarily stores, as information regarding the authentication tree, a part of the counter and the identifier included in the authentication tree and a tag generated using the counter and the identifier included in the authentication tree;
an authentication engine that performs an authentication process on the information regarding the authentication tree to be transferred between the authentication tree cache and the memory; and
management means for managing a storage status of the information regarding the authentication tree in the authentication tree cache based on at least one of a storage status of data in the data cache and a storage status of the information regarding the authentication tree in the authentication tree cache.
(Supplementary Note 2)

The information processing device according to Supplementary Note 1, wherein the management means manages the storage status of the information regarding the authentication tree in the authentication tree cache based on a status of accessing data stored in the data cache.
(Supplementary Note 3)

The information processing device according to Supplementary Note 2, wherein the management means performs management in such a way that the authentication tree cache retains a counter and a tag used for authentication of data stored in a cache of a predetermined upper layer and of data of which access frequency is equal to or more than predetermined frequency among a plurality of layers constituting the data cache.
(Supplementary Note 4)

The information processing device according to Supplementary Note 1, wherein the management means performs management in such a way that the authentication tree cache retains a counter and a tag used for authentication of data as an eviction candidate among pieces of data stored in the data cache.
(Supplementary Note 5)

The information processing device according to Supplementary Note 1, wherein the management means performs management in such a way that the authentication tree cache retains a counter and a tag used for authentication of data of a cache line in which meta-information indicates clean among pieces of data stored in the data cache with a higher priority than a counter and a tag used for authentication of data of a cache line in which meta-information indicates dirty.
(Supplementary Note 6)

The information processing device according to Supplementary Note 1, wherein the data cache is composed of n ways, and synchronizes at least one cache line among cache lines of a plurality of pieces of data constituting each index.
(Supplementary Note 7)

The information processing device according to Supplementary Note 1, wherein the management means performs management in such a way that the authentication tree cache retains a counter and a tag used for authentication of data included in information in a prefetch queue.
(Supplementary Note 8)

The information processing device according to Supplementary Note 1, wherein in a case where successive data in the data cache is read, when a counter of any node of the authentication tree is operated, the management means synchronizes a cache line of a read destination in the authentication tree cache for a counter of a node that is on the same layer as and adjacent to the operated node.
(Supplementary Note 9)

The information processing device according to Supplementary Note 1, wherein in a case where a counter of any node of the authentication tree and an associated tag are stored in different cache lines, when the counter of the any node is stored in the authentication tree cache, the management means performs management in such a way that the authentication tree cache acquires and stores the associated tag.
(Supplementary Note 10)

The information processing device according to Supplementary Note 1, wherein the data cache synchronizes a cache line of data associated with a counter that is not stored in the authentication tree cache, over a cache line of data associated with a counter that is not stored in the authentication tree cache.
(Supplementary Note 11)

The information processing device according to Supplementary Note 1,
wherein the authentication tree cache is composed of n ways, and
the management means synchronizes at least one cache line among cache lines of a plurality of counters constituting each index at a timing of accessing the authentication tree.
(Supplementary Note 12)

The information processing device according to Supplementary Note 1, wherein the management means synchronizes a counter of a node that is on the same layer as and adjacent to a node to which a counter evicted from the authentication tree cache belongs.
(Supplementary Note 13)

The information processing device according to Supplementary Note 1, wherein in a case where a cache line of any counter is to be evicted from the authentication tree cache 102, the management means synchronizes a cache line of a child node of a node of the cache line before the eviction.
(Supplementary Note 14)

The information processing device according to Supplementary Note 1, wherein the management means performs management in such a way that the authentication tree cache reads a counter of a parent node of a cache line to be synchronized among cache lines of counters stored in the authentication tree cache.
(Supplementary Note 15)

The information processing device according to Supplementary Note 1, wherein the management means synchronizes a cache line of a counter that is stored in the authentication tree cache and is used for authentication of data of a cache line evicted from the data cache.
(Supplementary Note 16)

A control method of an information processing device including a memory, a data cache, an authenticated encryption engine that performs, on data to be transferred between the data cache and the memory, an encryption process, and an authentication process using an authentication tree including a plurality of nodes linked in a tree shape, to each of which a combination of a counter and an identifier is assigned, an authentication tree cache that temporarily stores, as information regarding the authentication tree, a part of the counter and the identifier included in the authentication tree and a tag generated using the counter and the identifier included in the authentication tree, and an authentication engine that performs an authentication process on the information regarding the authentication tree to be transferred between the authentication tree cache and the memory, the control method including:
managing a storage status of the information regarding the authentication tree in the authentication tree cache based on at least one of a storage status of data in the data cache and a storage status of the information regarding the authentication tree in the authentication tree cache.
(Supplementary Note 17)

A non-transitory computer-readable medium in which a control program is stored, the control program causing a computer to execute a control process in an information processing device including a memory, a data cache, an authenticated encryption engine that performs, on data to be transferred between the data cache and the memory, an encryption process, and an authentication process using an authentication tree including a plurality of nodes linked in a tree shape, to each of which a combination of a counter and an identifier is assigned, an authentication tree cache that temporarily stores, as information regarding the authentication tree, a part of the counter and the identifier included in the authentication tree and a tag generated using the counter and the identifier included in the authentication tree, and an authentication engine that performs an authentication process on the information regarding the authentication tree to be transferred between the authentication tree cache and the memory, the control process including:
a process of managing a storage status of the information regarding the authentication tree in the authentication tree cache based on at least one of a storage status of data in the data cache and a storage status of the information regarding the authentication tree in the authentication tree cache.

### Reference Signs List

1 information processing device
100 cache
101 data cache
102 authentication tree cache
103 memory
104 authenticated encryption engine
105 authentication engine
106 synchronizer
107 prefetcher
108 tree traverser
109 replacement policy
110 buffer (read buffer)
111 buffer (overflow buffer)
112 key cache
113 synchronizer
120 management unit

What is claimed is:

1. An information processing device comprising:
a memory;
a data cache;
an authenticated encryption engine that performs, on data to be transferred between the data cache and the memory, an encryption process, and an authentication process using an authentication tree including a plurality of nodes linked in a tree shape, to each of which a combination of a counter and an identifier is assigned;
an authentication tree cache that temporarily stores, as information regarding the authentication tree, a part of the counter and the identifier included in the authentication tree and a tag generated using the counter and the identifier included in the authentication tree;
an authentication engine that performs an authentication process on the information regarding the authentication tree to be transferred between the authentication tree cache and the memory; and
management unit configured to manage a storage status of the information regarding the authentication tree in the authentication tree cache based on at least one of a storage status of data in the data cache and a storage status of the information regarding the authentication tree in the authentication tree cache.

2. The information processing device according to claim 1, wherein the management unit is configured to manage the storage status of the information regarding the authentication tree in the authentication tree cache based on a status of accessing data stored in the data cache.

3. The information processing device according to claim 2, wherein the management unit is configured to perform management in such a way that the authentication tree cache retains a counter and a tag used for authentication of data stored in a cache of a predetermined upper layer and of data of which access frequency is equal to or more than predetermined frequency among a plurality of layers constituting the data cache.

4. The information processing device according to claim 1, wherein the management unit is configured to perform management in such a way that the authentication tree cache retains a counter and a tag used for authentication of data as an eviction candidate among pieces of data stored in the data cache.

5. The information processing device according to claim 1, wherein the management unit is configured to perform management in such a way that the authentication tree cache retains a counter and a tag used for authentication of data of a cache line in which meta-information indicates clean among pieces of data stored in the data cache with a higher priority than a counter and a tag used for authentication of data of a cache line in which meta-information indicates dirty.

6. The information processing device according to claim 1, wherein the data cache is composed of n ways, and synchronizes at least one cache line among cache lines of a plurality of pieces of data constituting each index.

7. The information processing device according to claim 1, wherein the management unit is configured to perform management in such a way that the authentication tree cache retains a counter and a tag used for authentication of data included in information in a prefetch queue.

8. The information processing device according to claim 1, wherein in a case where successive data in the data cache is read, when a counter of any node of the authentication tree is operated, the management unit is configured to synchronize a cache line of a read destination in the authentication tree cache for a counter of a node that is on the same layer as and adjacent to the operated node.

9. The information processing device according to claim 1, wherein in a case where a counter of any node of the authentication tree and an associated tag are stored in different cache lines, when the counter of the any node is stored in the authentication tree cache, the management unit is configured to perform management in such a way that the authentication tree cache acquires and stores the associated tag.

10. The information processing device according to claim 1, wherein the data cache synchronizes a cache line of data associated with a counter that is not stored in the authentication tree cache, over a cache line of data associated with a counter that is not stored in the authentication tree cache.

11. The information processing device according to claim 1,
wherein the authentication tree cache is composed of n ways, and
the management unit is configured to synchronize at least one cache line among cache lines of a plurality of counters constituting each index at a timing of accessing the authentication tree.

12. The information processing device according to claim 1, wherein the management unit is configured to synchronize a counter of a node that is on the same layer as and adjacent to a node to which a counter evicted from the authentication tree cache belongs.

13. The information processing device according to claim 1, wherein in a case where a cache line of any counter is to be evicted from the authentication tree cache, the management unit is configured to synchronize a cache line of a child node of a node of the cache line before the eviction.

14. The information processing device according to claim 1, wherein the management unit is configured to perform management in such a way that the authentication tree cache reads a counter of a parent node of a cache line to be synchronized among cache lines of counters stored in the authentication tree cache.

15. The information processing device according to claim 1, wherein the management unit is configured to synchronize a cache line of a counter that is stored in the authentication tree cache and is used for authentication of data of a cache line evicted from the data cache.

16. A control method of an information processing device including a memory, a data cache, an authenticated encryption engine that performs, on data to be transferred between the data cache and the memory, an encryption process, and an authentication process using an authentication tree including a plurality of nodes linked in a tree shape, to each of which a combination of a counter and an identifier is assigned, an authentication tree cache that temporarily stores, as information regarding the authentication tree, a part of the counter and the identifier included in the authentication tree and a tag generated using the counter and the identifier included in the authentication tree, and an authentication engine that performs an authentication process on the information regarding the authentication tree to be transferred between the authentication tree cache and the memory, the control method comprising:
managing a storage status of the information regarding the authentication tree in the authentication tree cache based on at least one of a storage status of data in the data cache and a storage status of the information regarding the authentication tree in the authentication tree cache.

17. A non-transitory computer-readable medium in which a control program is stored, the control program causing a computer to execute a control process in an information processing device including a memory, a data cache, an authenticated encryption engine that performs, on data to be transferred between the data cache and the memory, an encryption process, and an authentication process using an authentication tree including a plurality of nodes linked in a tree shape, to each of which a combination of a counter and an identifier is assigned, an authentication tree cache that temporarily stores, as information regarding the authentication tree, a part of the counter and the identifier included in the authentication tree and a tag generated using the counter and the identifier included in the authentication tree, and an authentication engine that performs an authentication process on the information regarding the authentication tree to be transferred between the authentication tree cache and the memory, the control process comprising:
a process of managing a storage status of the information regarding the authentication tree in the authentication tree cache based on at least one of a storage status of data in the data cache and a storage status of the information regarding the authentication tree in the authentication tree cache.
